(19) United States
(12) Patent Application Publication
(10) Pub. No.: US 2026/0055841 A1
(43) Pub. Date: Feb. 26, 2026

(54) VIBRATION ATTENUATION SUPPORT FOR PIPELINES WITH THERMAL EXPANSION MOVEMENT

(71) Applicant: Petróleo Brasileiro S.A. – Petrobras, Rio de Janeiro (BR)

(72) Inventors: Claudio Jose GRANDO DA CUNHA, Canoas (BR); Alberto WARTCHOW, Canoas (BR)

(21) Appl. No.: 19/300,458

(22) Filed: Aug. 14, 2025

(30) Foreign Application Priority Data
Aug. 23, 2024 (BR) 1020240173074

(51) Int. Cl. F16L 55/04

(52) U.S. Cl. CPC F16L 55/041

(57) ABSTRACT

Embodiments include an attenuation support to support or mitigate movement of an element, mainly a pipe of a pipeline, in which the movement comprises vibration and/or thermal expansion. The support can include damping elements, spacer elements, a housing housing the damping elements and the spacer elements, a rod extending through the housing, in which the damping elements and the spacer elements are intercalated with each other within the housing.

The rod can be mounted with radial interference in relation to the damping elements. The damping elements can be hollow discs of elastomeric material, and the spacer elements can be hollow discs of rigid material. When thermal expansion movement of a pipe occurs, the rod moves in relation to the damping elements. When the dynamic movement occurs due to vibration of the pipe, friction between the rod and the damping elements deforms the latter, causing a hysteretic damping of the movement.

### CROSS-REFERENCE TO RELATED APPLICATIONS

This application claims priority to Brazilian Patent Application No. 1020240173074, filed Aug. 23, 2024, which is incorporated herein in its entirety by reference thereto.

### FIELD

The present disclosure falls within the field of mechanical engineering. More specifically, the present disclosure relates to a support for pipelines, suitable for damping movements originating from vibrations, but allowing expansions due to thermal expansion.

### BACKGROUND

Supporting hot pipelines with high thermal expansion, and that present vibration, represents a challenge in the art. Conventional supports of the guide or lock type (with or without an elastomeric element) restrict the movement, whether vibratory or thermal expansion; however, when the vibratory movement of the pipeline is in the same direction as the thermal expansion movement, the use of conventional supports is not possible. Another important issue is the need for a solution with the possibility of field adjustment to obtain adequate characteristics of strength, rigidity and absorption of dynamic energy.

One solution is the use of hydraulic dampers, which allow thermal expansion to occur; however, their application is not specific to pipe vibration, but rather to impulse loads such as water hammer and seismic loads (“snubbers”), used, for example, in pipelines with two-phase flow. This model may fail with hydraulic oil leaks, requiring the component to be replaced. Another solution is the use of viscous element dampers, which allow the absorption of thermal expansion movements in the pipeline, but become inadequate when the expansion values are high, due to their limited stroke. Another option is the “sway brace” model, which has an internal spring that absorbs a certain expansion, normally up to 3 inches (7.62 cm), and, after this, prevents the vibration due to the restriction imposed.

Document DE2834649A1, titled “Motor vehicle vibration damper”, describes a shock and vibration damper, especially suitable for motor vehicles. It operates by friction, having a piston sliding in a cylinder. At the end of the cylinder (2) from which the piston rod (3) protrudes, a brake (7′) is provided for the rod, comprising a stack of wear-resistant discs (7) through which it passes and of rubber-like elastic material, mainly plastic, attached to the cylinder. At the inner end of the rod, there is a piston (5) guiding the same in the cylinder. The piston may be formed by membrane-like discs of wear-resistant plastic and elastic material (16) attached to the rod, which passes through the same. More specifically, document DE2834649A1 discloses a polygonal disc in the shape of an equilateral triangle that is placed on top of the stack of membrane discs. This disc bends when the rod is inserted, but does not do so when it is removed. Thus, it is easier to insert than to remove the piston. It also suggests that several polygonal discs may be inserted between the membrane discs in a misaligned manner with each other.

Document WO9514830A1, titled “Seismic isolation bearing”, discloses a seismic isolation bearing including an upper load plate (11A) for attaching the bearing to a structure to be supported, a lower load plate (11B) for attaching the bearing assembly to the foundation, and a steel-reinforced rubber bearing body (13) sandwiched therebetween. The rubber bearing body (13) performs the functions of both bearing and restoring the seismic isolation bearing. A steel midplate (14) extends radially from the middle of the rolled stack of the bearing body, and includes a plurality of holes (35) proximate to the outer circumference of the midplate. A first series of yield pins (12T) is anchored in the upper load plate and extends downward toward the lower load plate, and a second series of yield pins (12B) is anchored in the lower load plate and extends upward toward the upper load plate. The yield pins (12T, 12B) are received within oversized holes (35) arranged around the periphery of the midplate. During lateral displacement of the bearing assembly, the midplate (14) deflects and plastically deforms the pins; upon cessation of the applied lateral force, the elastomeric support body urges the assembly back to its original position, plastically reforming the yield pins to their original position. The yield function of the yield pins is thus decoupled from the bearing and restores the function of the rolling body (13). Document WO9514830A1 also discloses the construction of a rubber and metal interspersed bearing comprising a central hole for the insertion of a piston rod or pin.

### SUMMARY

The present disclosure consists of a support that has a rod inserted with interference in a set of viscoelastic elements (for example: elastomers, rubber, polyurethane), which restricts the vibratory movement and practically allows any course of movement imposed by thermal expansion. The configuration of the support, with the use of a “sandwich” of viscoelastic elements interspersed with rigid elements, allows for the easy alteration of the dynamic and rigidity characteristics, by modifying the quantities and/or dimensions of the elements. It is a low-cost manufacturing and maintenance solution, suitable for common piping applications, both cold and hot, in process units.

The present disclosure is applicable to the support or damping of movement of a pipeline, in which the movement to be supported or damped includes vibration and/or thermal expansion, for example, pipelines with vibration induced by the flow of fluids and in compressor piping systems, in the typical frequency range up to 20 Hz. The present disclosure is applicable to hot pipelines that present high thermal expansion movements, without being limited to these. For example, the present disclosure can also be applied to cold pipelines.

### BRIEF DESCRIPTION OF THE DRAWINGS

The present disclosure will be described below with reference to the typical embodiments thereof and also with reference to the attached drawings, in which:

FIG. 1 is a representation of the attenuation support, according to the present disclosure;

FIGS. 2A and 2B are cross-sectional views of some embodiments of the attenuation support, according to the present disclosure;

FIG. 2C is a top view of the elastomeric disc of the attenuation support, according to the present disclosure;

FIGS. 3A and 3B are representations of the operation of the support to absorb thermal expansion movements, according to the present disclosure;

FIG. 4 is a detailed representation of the sandwich of damping and spacer elements, according to the present disclosure;

FIG. 5 is a cross-sectional view of the attenuation support illustrating the forces in action, according to the present disclosure in operation;

FIGS. 6A and 6B are cross-sectional views of the attenuation support illustrating the difference in results with the variation of the spacer elements, according to the present disclosure;

FIG. 7 is a representation of the attenuation support partially disassembled, according to the present disclosure;

FIG. 8 is a representation of the attenuation support in use, according to the present disclosure;

FIG. 9 is a representation of an alternative embodiment of installation of the attenuation support in use, in accordance with the present disclosure;

FIG. 10 is a representation of the front and plan views of an alternative embodiment of installation of the attenuation support in use, in accordance with the present disclosure.

### DETAILED DESCRIPTION

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system and business-related constraints, which may vary from one implementation to another. In addition, it should be appreciated that such a development effort may be complex and time-consuming, but would nevertheless be a routine design and manufacturing undertaking for those of ordinary skill having the benefit of this disclosure.

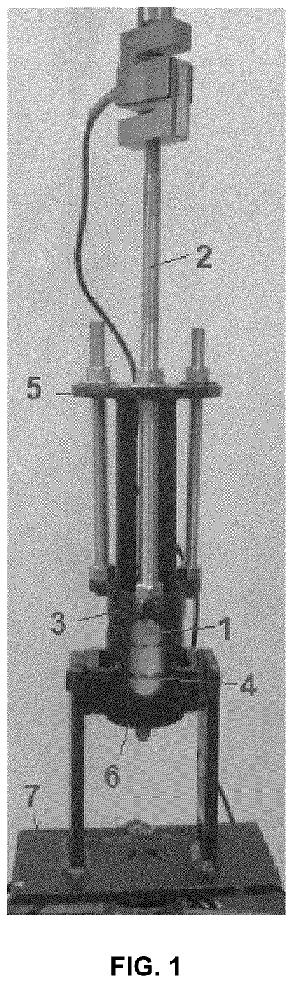

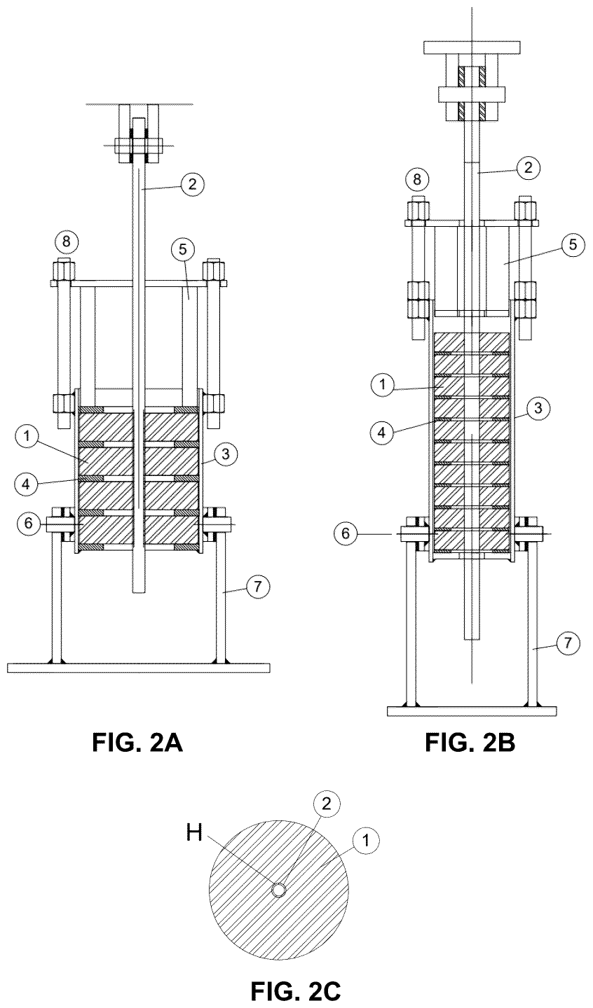

The present disclosure is described in a general manner and without limitation with reference to FIG. 1 and the cross-sectional representations in FIGS. 2A and 2B. The attenuating support according to the present disclosure comprises multiple damping elements (1) in the form of multiple elastomeric discs, multiple spacer elements (4) in the form of multiple rigid discs, a housing (3) housing the damping elements (1) and the spacer elements (4), a rod (2) passing through the housing (3), a press (5), a ball joint (6) at the base of the housing (3), and a base (7) to support the attenuating support.

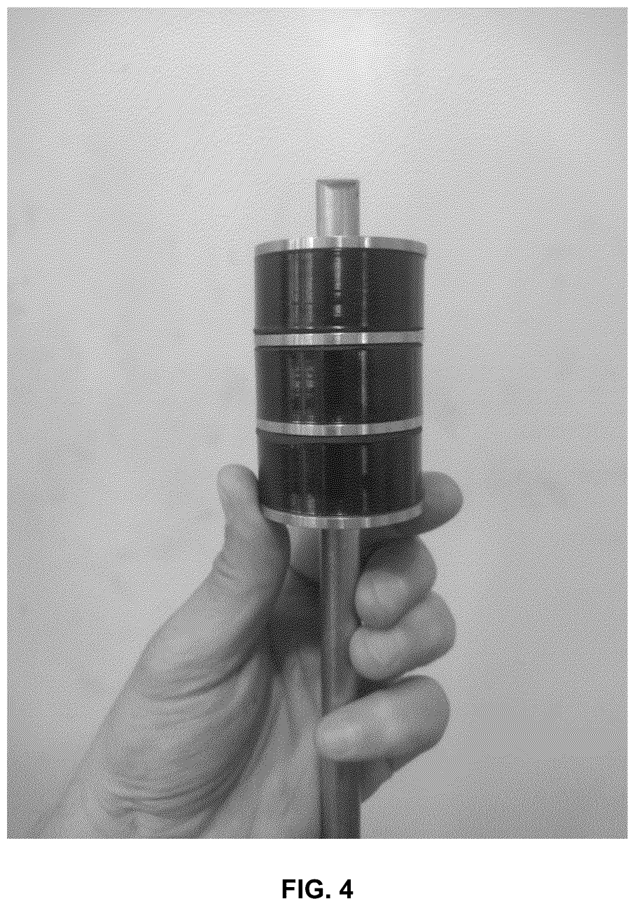

The damping elements (1) comprise multiple hollow discs of elastomeric material, for example, nitrile, butyl and polyurethane rubber, with typical hardnesses in the range between 50 and 80 shore A. The spacer elements (4) comprise multiple hollow discs of rigid material, for example, stainless steel. The elastomeric discs and the rigid discs are intercalated concentrically to form a “sandwich”, shown in FIG. 4. The rigid discs have a usual thickness of ⅛″ (3.175 mm), meeting the requirement of being greater than the amplitude of vibration to be attenuated. Naturally, this usual thickness is merely illustrative and not limitative. For example, the elastomeric discs can have an external diameter of 50 mm or 70 mm, without limitation.

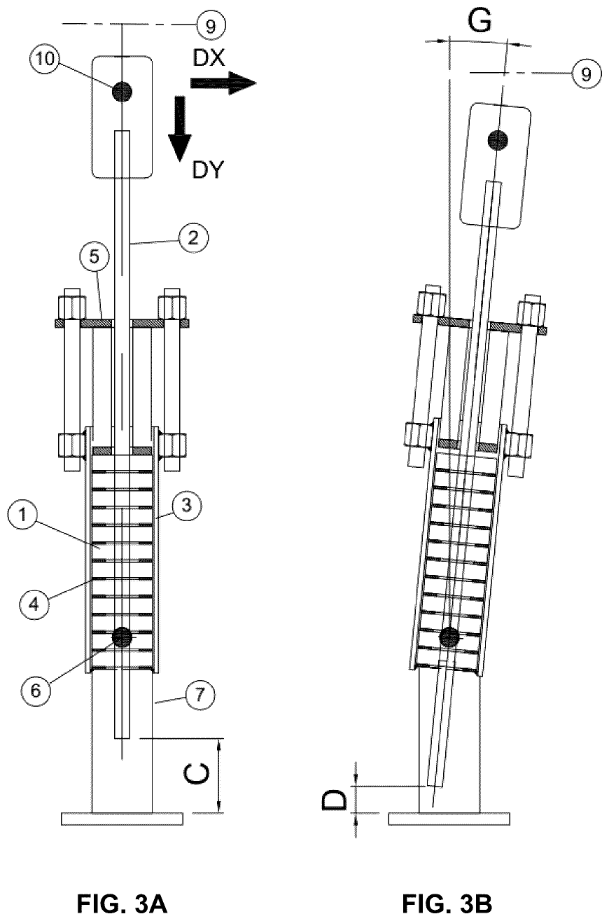

The housing (3) is attached to the base through the ball joint (6), which allows the support to rotate (arrow G) from the initial position to the final position after the compound thermal expansion movement (arrows DX and DY) of the pipeline (9), as exemplified in FIGS. 3A and 3B. The initial assembly position of the rod is represented by dimension (C), while the final position, after the expansion movement, is represented by dimension (D). The ball joint (6) must have clearance between the drilling and the pin with precision machining adjustment, for example H11 d11 and H10 d10, so as not to impact the dynamic operation.

The rod (2) is attached by one of its ends to the element whose movement is intended to be supported or damped, for example, a pipe that transports fluids and has vibration and/or thermal expansion. The rod (2) is attached to the element, for example, through an eyelet with a pin that functions as a second ball joint (10) and, like the ball joint (6), must have clearance with machining precision so as not to impact the dynamic operation.

The rod (2) is inserted into the housing (3) through the central holes of the elastomeric discs (1), as seen in FIGS. 2A and 2B. The diameter of the rod (2) is larger than the diameter of the central holes of the elastomeric discs (1), so that the assembly has radial interference represented by (H) in FIG. 2C. When the thermal expansion movement of the element (9), for example, a pipeline, the rod (2) moves in relation to the elastomeric discs (1) to a position of equilibrium. The function of the press (5) is to eliminate clearances between the elements of the “sandwich” during assembly. When the element (9) vibrates or moves dynamically, the rod (2) directly transmits the force to the damping elements (1). The friction between the rod (2) and each damping element (1), resulting from the assembly interference (H), causes each damping element (1) to dynamically deform in the same direction as the movement of the rod (2).

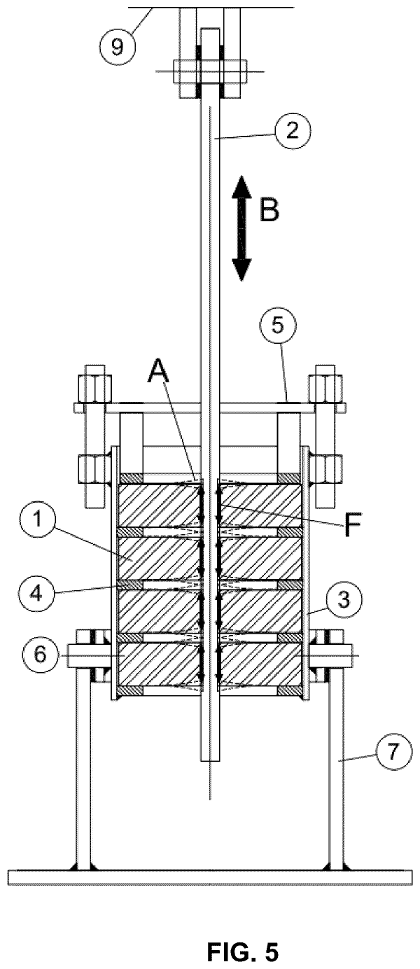

The deformation of the elastomeric discs is illustrated in FIG. 5 by the dotted lines (A). The dynamic force (B) transmitted by the rod (2), coming from the pipeline (9), in the direction of the damping elements (1), has an opposite reaction of friction force in each damping element, represented by the arrows (F), which in turn results in the dynamic deformation (A) of the elastomeric discs. This deformation provides a hysteretic damping to the movement of the rod (2) and, in turn, to the vibration movement of the pipeline (9). As is known, the hysteresis dissipates part of the dynamic deformation energy into heat through internal friction. Advantageously, the hysteretic damping provided by the damping elements of the present disclosure reduces the amplitude and the dynamic energy of the system.

The central hole of the rigid disks has a larger diameter than the central hole of the elastomeric disks. This difference in size introduces a clearance or gap between each elastomeric disk of the sandwich, as can be seen in FIGS. 2A and 2B. The blank spaces between each damping element (1) represent the clearance or gap resulting from the difference in size between the central holes of the elastomeric disks and the rigid disks.

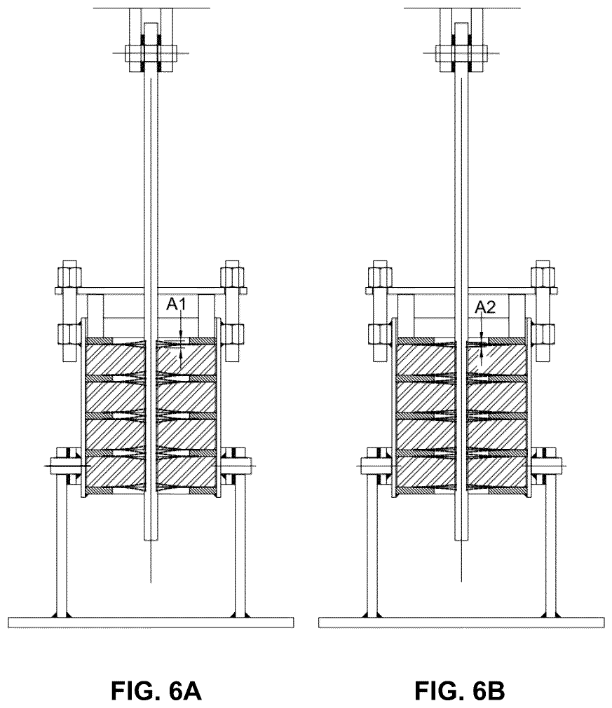

The variation in the size of the central hole of the spacer elements (4) provides a variation in the stiffness of the damping elements (1), altering the values of deformation amplitude, represented by (A1) and (A2) in FIGS. 6A and 6B. The maximum stiffness is achieved when the diameter of the holes in the steel discs approaches the diameter of the rod or when the steel discs are removed. Increasing the diameter of the holes in the rigid discs reduces the stiffness of the damper, with a recommended limit being the average diameter of the resilient disc. The stiffness of the damping elements (1) directly impacts the dynamic behavior of the system as a whole, such as, for example, its natural frequencies. Advantageously, the possibility of varying the stiffness in a simple way using the same device allows the natural frequency of the system to be varied, that is, to calibrate the system.

The maximum dynamic force allowed by the attenuation support of the present disclosure is defined by the friction force between the damping elements (1) and the rod (2). For dynamic or static loads greater than the friction force, a relative displacement will occur between the damping elements (1) and the rod (2). The dynamic characteristics of stiffness, damping and acting friction forces will depend on the geometry and characteristics of the elastomeric materials, on the dimensions of the spacer elements (4) and on the number of damping elements (1). Changing the type and hardness of the elastomeric material influences the stiffness and energy absorption response. Less hard materials have less stiffness. The hysteresis curve will be more or less pronounced depending on the type of material.

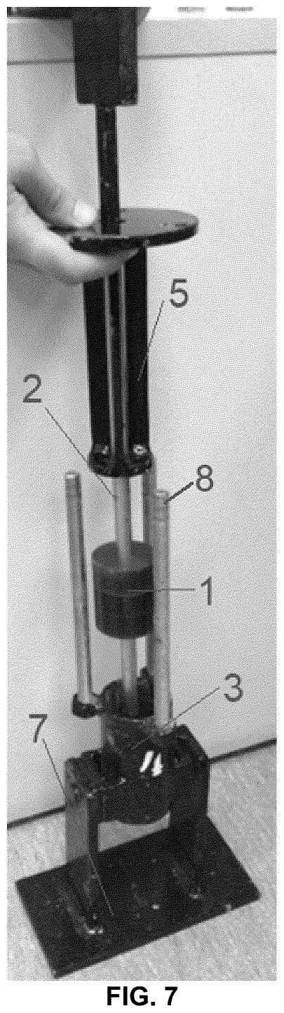

FIG. 7 illustrates the attenuation support of the present disclosure partially disassembled, with the sandwich removed from the housing (3) and with the press (5) removed. When assembled, the press (5), fixed by the screws (8), eliminates the clearance in the sandwich, fixing the same in place and preventing it from moving together with the rod (2).

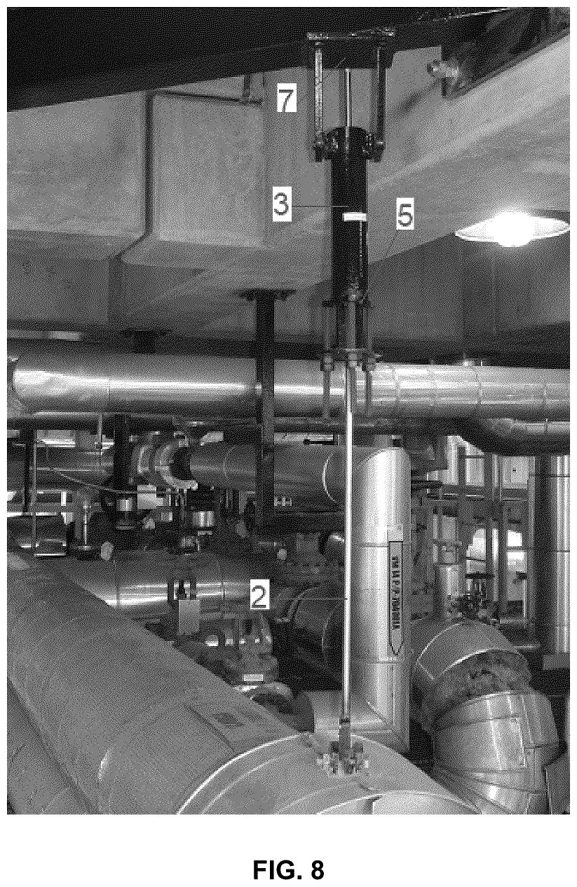

FIG. 8 illustrates an example of use of the attenuation support according to the present disclosure. The rod (2) is fixed to the surface of the pipe and the base (7) is fixed to a surface of an opposite structure in the environment.

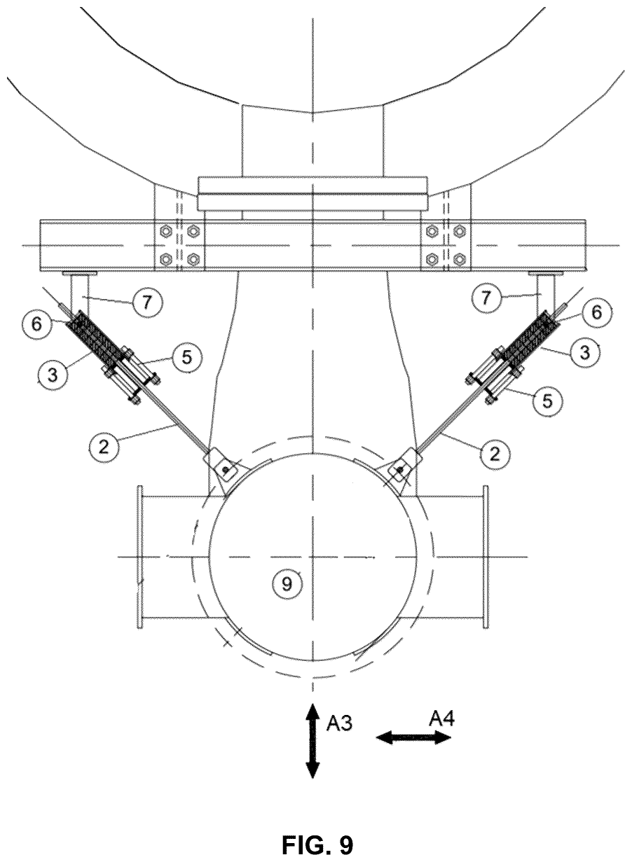

The attenuation support of the present disclosure will be installed so as to be oriented in the direction of the vibration movement. However, this may not be possible due to the spatial configuration of the pipelines in relation to the point of attachment of the support. The orientation of the connection of the base (7) and the housing (3) can be adapted to allow the housing to be inclined in relation to the base, as exemplified in FIG. 9. In an alternative assembly, two supports can be used, which makes it possible to restrict dynamic movements in two directions, such as, for example, those indicated by (A3) and (A4), in the plan view of FIG. 9.

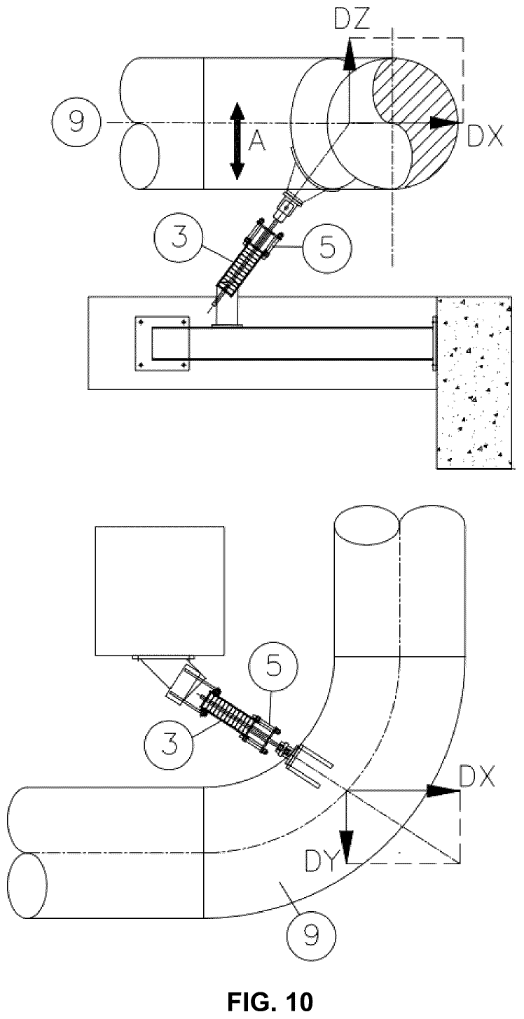

Other configurations are possible without departing from the scope of the present disclosure. For example, in an installation position that allows the combined movements DX, DY and DZ of spatial expansion of the element (9), and the rod (2) positioned predominantly in the same direction as the dynamic movement (A) that is intended to be dumped, as exemplified in the front and plan views of FIG. 10.

The present disclosure is applicable to the support or damping of movement of a pipe in a pipeline and the movement to be supported or dumped includes vibration and/or thermal expansion, for example, pipelines with vibration induced by the flow of fluids and in compressor piping systems, in the typical frequency range up to 20 Hz. The present disclosure is applicable to hot pipelines that present high thermal expansion movements, without being limited to these. For example, the present disclosure can also be applied to cold pipelines.

The advantages of the present disclosure will become evident to those skilled in the art and include:
Low-cost system compared to the available solutions of the state of the art, which will allow implementation on a larger scale in usual piping applications that present dynamic loads;
Increased reliability of the installations in order to avoid unexpected high vibrations and fatigue in pipelines and process equipment;
Compared to vibration dampers of the state of the art, this presents the advantage of allowing high travel or movements of the equipment (e.g., a pipeline) to which it is connected, by means of a simple and low-complexity solution. It is therefore applicable to pipelines in general with dynamic loads, with the advantage of being usable at points of pipelines with high thermal expansion;
The support is easy to assemble and disassemble by using the press (5), to adjust the dynamic characteristics by replacing, adding or removing elements in operation, and for maintenance changes. The possibility of varying the stiffness, using the same device, allows adjusting the natural frequency and the response of the system in a simple way, configuring an advantage, because the response actually obtained is often not exactly the same as the calculation model, requiring field adjustments in relation to the support dimensioned at the designing step. Variations in the operation of the elements to be damped are also contemplated by the ability of the present disclosure to be easily adjusted.

Although aspects of the present disclosure may be susceptible to various modifications and alternative forms, specific embodiments have been shown by way of example in the drawings and have been described in detail in this document. But it should be understood that the disclosure is not intended to be limited to the particular disclosed forms. Rather, the disclosure should encompass all modifications, equivalents and alternatives that fall within the scope of the disclosure, such as those defined by the following appended claims.

1. A vibration attenuation support for pipelines with thermal expansion, comprising:
damping elements;
spacer elements;
a housing comprising the damping elements and the spacer elements;
a rod extending through the housing; and
a press,
wherein the damping elements and the spacer elements are intercalated with each other within the housing.

2. The vibration attenuation support for pipelines with thermal expansion, according to claim 1,
wherein the damping elements are hollow discs comprising a central hole and an elastomeric material,
wherein the spacer elements are hollow discs comprising a central hole and a rigid material, and
wherein the spacer elements have a central hole diameter greater than a central hole diameter of the damping elements.

3. The vibration attenuation support for pipelines with thermal expansion, according to claim 1, wherein the rod is inserted with radial interference in a central hole of the damping elements.

4. The vibration attenuation support for pipelines with thermal expansion, according to claim 1, wherein the housing and the rod are configured to couple by a ball joint with a clearance that allows expansion movements and allows rotation to an inclined position in relation to a base of the vibration attenuation support.
